(19) United States
(12) Patent Application Publication
(10) Pub. No.: US 2016/0278174 A1
(43) Pub. Date: Sep. 22, 2016

(54) LIGHT-EMITTING DEVICE

(71) Applicant: EPISTAR CORPORATION, Hsinchu (TW)

(72) Inventors: Chao Hsing CHEN, Hsinchu City (TW); Alexander Chang WANG, Hsinchu City (TW); Chia-Ling HSU, Hsinchu City (TW)

(21) Appl. No.: 15/171,748

(22) Filed: Jun. 2, 2016

Related U.S. Application Data
(63) Continuation of application No. 12/981,788, filed on Dec. 30, 2010.

(30) Foreign Application Priority Data
Dec. 31, 2009 (TW) 098146645

(51) Int. Cl. H05B 33/08

(52) U.S. Cl. CPC H05B 33/0821

(57) ABSTRACT

A light-emitting device includes an insulating carrier; a light-emitting array formed on the insulating carrier including a first light-emitting circuit having a first light-emitting unit, wherein the first light-emitting circuit is a one-way circuit, a second light-emitting circuit having a second light-emitting unit, wherein the second light-emitting circuit is a one-way circuit, a first conductive layer, a second conductive layer, and a third conductive layer, wherein the first light-emitting circuit is formed between the first conductive layer and the second conductive layer and connects with them electrically, the second light-emitting circuit is formed between the second conductive layer and the third conductive layer and connects with them electrically, wherein an area of the second conductive layer is greater or equal to 1.9×10³ μm².

### REFERENCE TO RELATED APPLICATION

This application is a continuation application of U.S. patent application Ser. No. 12/981,788 (EPIS/0013US) filed on Dec. 30, 2010 which claims the right of priority based on TW application Ser. No. 098146645 filed on Dec. 31, 2009, which are incorporated herein by reference and assigned to the assignee herein.

### TECHNICAL FIELD

The application relates to an array-type light-emitting device.

### DESCRIPTION OF BACKGROUND ART

The Light Emitting Diode (LED) is a solid state semiconductor element comprising good photoelectrical features such as a low power-consumption, low heat-generation, long life, high shock-endurance, small size, quick reaction, and the fine color light emitted in a stable wavelength, so the LED is usually applied to the fields such as home appliances, indicators of instrumentations, and photoelectrical products. Along with the advance of photoelectrical technology, the solid state semiconductor has huge advances in the aspects comprising the improvement of the light-emitting efficiency, operation life and brightness.

Normally, a conventional LED is driven by DC power, so a convertor is needed between the conventional LED and an AC power. However, the convertor has big volume and heavy weight so the cost is increased. Furthermore, the electricity conversion causes power loss so the conventional LED is not suitable for the present light source.

The emergence of AC light-emitting diode solves the drawbacks mentioned above. Without the need of the converter, not only the usable space is increased because of the reduction of the volume and weight of LED, but the cost of the converter is saved, and the power loss during the DC/AC conversion is 15% less, therefore the total efficiency of the AC LED increased.

### SUMMARY OF THE DISCLOSURE

The present application discloses an array-type light-emitting device including an insulating carrier; a light-emitting array formed on the insulating carrier including a first light-emitting circuit having a first light-emitting unit wherein the first light-emitting circuit is a one-way circuit, a second light-emitting circuit having a second light-emitting unit wherein the second light-emitting circuit is a one-way circuit, a first conductive layer, a second conductive layer, and a third conductive layer, wherein the first light-emitting circuit is formed between the first conductive layer and the second conductive layer and connects with them electrically, and the second light-emitting circuit is formed between the second conductive layer and the third conductive layer and connects with them electrically, wherein an area of the second conductive layer is greater or equal to 1.9×10³ μm².

### BRIEF DESCRIPTION OF THE DRAWINGS

FIG. 1 illustrates a schematic diagram of an array-type light-emitting device in accordance with one embodiment of the present application.

FIG. 2A illustrates a top view of an array-type light-emitting device in accordance with one embodiment of the present application.

FIG. 2B illustrates a corresponding circuit of the array-type light-emitting device shown in FIG. 2A.

FIG. 3A illustrates a top view of an array-type light-emitting device in accordance with one embodiment of the present application.

FIG. 3B illustrates a corresponding circuit of the array-type light-emitting device shown in FIG. 3A.

FIG. 4A illustrates a top view of an array-type light-emitting device in accordance with one embodiment of the present application.

FIG. 4B illustrates a corresponding circuit of the array-type light-emitting device shown in FIG. 3A.

FIG. 5 illustrates a schematic diagram of an array-type light-emitting device in accordance with one embodiment of the present application.

FIG. 6A illustrates a top view of an array-type light-emitting device in accordance with one embodiment of the present application.

FIG. 6B illustrates a corresponding circuit of the array-type light-emitting device shown in FIG. 6A.

FIG. 7A illustrates a top view of an array-type light-emitting device in accordance with one the embodiment of the present application.

FIG. 7B illustrates a corresponding circuit of the array-type light-emitting device of FIG. 6A.

FIG. 8A illustrates a top view of an array-type light-emitting device in accordance with one embodiment of the present application.

FIG. 8B illustrates a corresponding circuit of the array-type light-emitting device shown in FIG. 8A.

FIG. 9 illustrates a schematic diagram of an array-type light-emitting device in accordance with one embodiment of the present application.

FIG. 10A illustrates a top view of an array-type light-emitting device in accordance with one embodiment of the present application.

FIG. 10B illustrates a corresponding circuit of the array-type light-emitting device shown in FIG. 10A.

FIG. 11A illustrates a top view of an array-type light-emitting device in accordance with one embodiment of the present application.

FIG. 11B illustrates a corresponding circuit of the array-type light-emitting device shown in FIG. 11A.

FIG. 12 illustrates a schematic diagram of an array-type light-emitting device in accordance with one embodiment of the present application.

FIG. 13A illustrates a top view of an array-type light-emitting device in accordance with one embodiment of the present application.

FIG. 13B illustrates a corresponding circuit of the array-type light-emitting device shown in FIG. 13A.

FIG. 14A illustrates a top view of an array-type light-emitting device in accordance with one embodiment of the present application.

FIG. 14B illustrates a corresponding circuit of the array-type light-emitting device shown in FIG. 14A.

FIG. 15 illustrates a schematic diagram of an array-type light-emitting device in accordance with one embodiment of the present application.

FIG. 16A illustrates a top view of an array-type light-emitting device in accordance with one embodiment of the present application.

FIG. 16B illustrates a corresponding circuit of the array-type light-emitting device shown in FIG. 16A.

FIG. 17A illustrates a top view of an array-type light-emitting device in accordance with one embodiment of the present application.

FIG. 17B illustrates a corresponding circuit of the array-type light-emitting device shown in FIG. 17A.

FIG. 18 illustrates a schematic diagram of an array-type light-emitting device in accordance with one embodiment of the present application.

FIG. 19 illustrates a corresponding circuit of the array-type light-emitting device shown in FIG. 18.

FIG. 20 illustrates a schematic diagram of an array-type light-emitting device in accordance with one embodiment of the present application.

FIG. 21 illustrates a top view of an array-type light-emitting device in accordance with one embodiment of the present application.

FIG. 22 illustrates a top view of an array-type light-emitting device in accordance with one embodiment of the present application.

FIG. 23 illustrates a top view of an array-type light-emitting device in accordance with one embodiment of the present application.

FIG. 24 illustrates a schematic diagram of a package of an array-type light-emitting device in accordance with one embodiment of the present application.

FIG. 25 illustrates a schematic diagram of a package of an array-type light-emitting device in accordance with one embodiment of the present application.

FIG. 26A illustrates a schematic circuit of a light-emitting module of the present application.

FIG. 26B illustrates a schematic circuit of a light-emitting module of the present application.

FIG. 26C illustrates a schematic circuit of a light-emitting module of the present application.

FIG. 27 illustrates a schematic circuit of a light-emitting module of the present application.

### DETAILED DESCRIPTION OF PREFERRED EMBODIMENTS

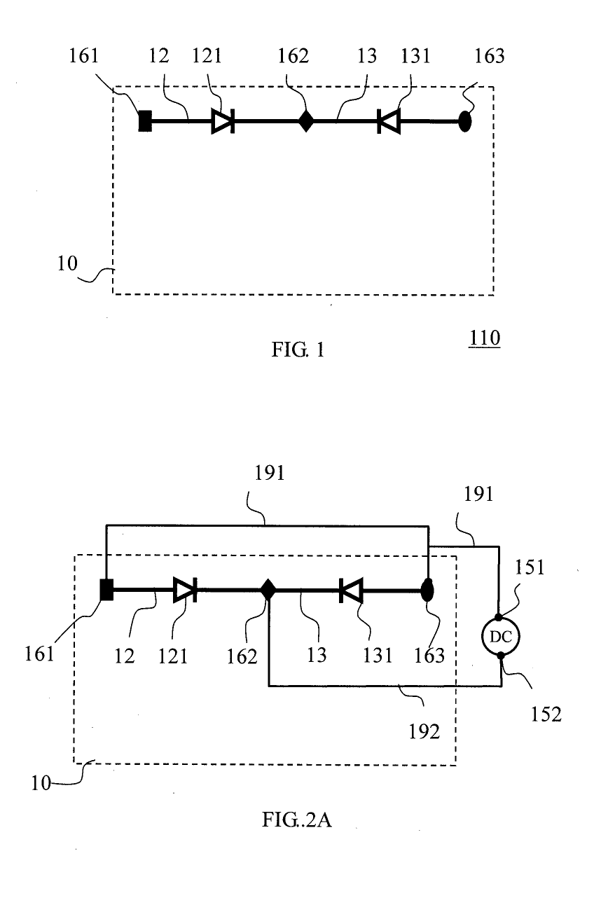

Referring to FIG. 1, a schematic diagram of an array-type light-emitting device in accordance with a first embodiment of the present application is disclosed. The light-emitting device includes an insulating carrier 10; a first light-emitting circuit element 12 including a first light-emitting unit 121 formed on the insulating carrier 10, wherein the first light-emitting circuit 12 is a one-way circuit; a second light-emitting circuit 13 including a second light-emitting unit 131 formed on the insulating carrier 10, wherein the second light-emitting circuit 13 is a one-way circuit; a first conductive layer 161 formed on the insulating carrier 10; a second conductive layer 162 formed on the insulating carrier 10; and a third conductive layer 163 formed on the insulating carrier 10; wherein the first light-emitting circuit 12 is formed between the first conductive layer 161 and the second conductive layer 162 and connects with them electrically, and the second light-emitting circuit 13 is formed between the second conductive layer 162 and the third conductive layer 163 and connects with them electrically.

In the present embodiment, the way to form an electric connection is to form a conductive film between the light-emitting device and the conductive layers by lithography and etching, or to form a wire with one end attaching to a bonding electrode of the light-emitting unit, and the other end thereof attaching to the conductive layers, therefore the electric connection is formed by the conductive film or the wire. The light-emitting device 110 can be connected to the conductive layers and an external power supply by wire bonding for serially connecting to a circuit based on the demands of a user. By this way, the areas of the first conductive layer 161, the second conductive layer 162 and the third conductive layer 163 need to be sufficient for accommodating the wire for wire bonding so the current can flow smoothly to the light-emitting device 110. In the present embodiment, the areas of the first conductive layer 161, the second conductive layer 162 and the third conductive layer 163 should be greater or equal to 1.9×10³ μm². To be more specific, in the present embodiment, the area of the first conductive layer 161, the second conductive layer 162 and the third conductive layer 163 is 3.8×10³ μm², 3.8×10³ μm², and 3.8×10³ μm², respectively. The details are disclosed in the following description.

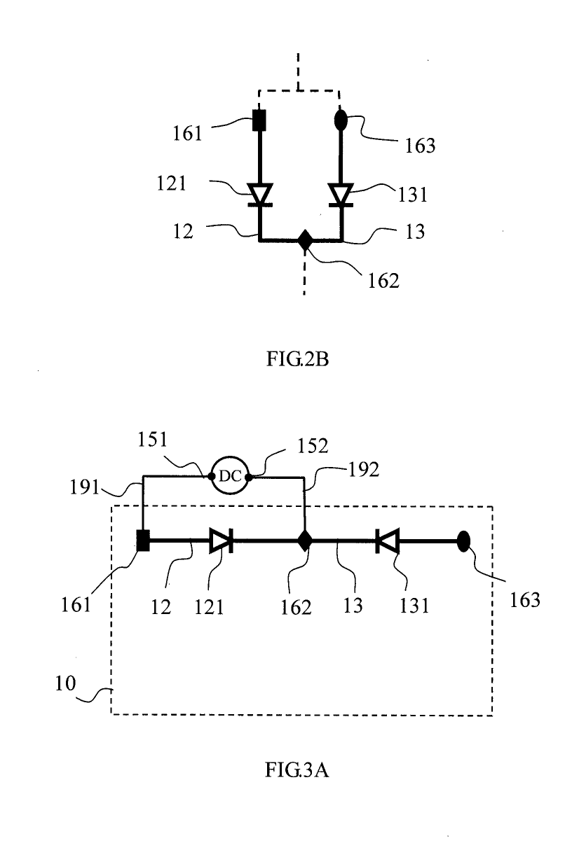

Referring to FIG. 2A and FIG. 2B, the array-type light-emitting device 110 can form a light-emitting device circuit by serially connecting the conductive layers of the light-emitting device 110 based on the need of the users. In the present embodiment, the direction of the first light-emitting circuit 12 is from the first conductive layer 161 to the second conductive layer 162, and the direction of the second light-emitting circuit 13 is from the third conductive layer 163 to the second conductive layer 162. The first conductive layer 161 and the third conductive layer 163 is respectively connected to a first contact 151 of an external power supply via a wire 191, and the second conductive layer 162 is connected to a second contact 152 of the external power supply via another wire 192. After the current is supplied from the external power supply, the current flows into the first light-emitting unit 121 and the second light-emitting unit 131 from the first contact 151, and then flows out from the second conductive layer 162 so the first light-emitting unit 121 or the second light-emitting unit 131 emits light. The first light-emitting unit 121 and the second light-emitting unit 131 are connected in parallel. FIG. 2B is the corresponding circuit diagram of the present embodiment.

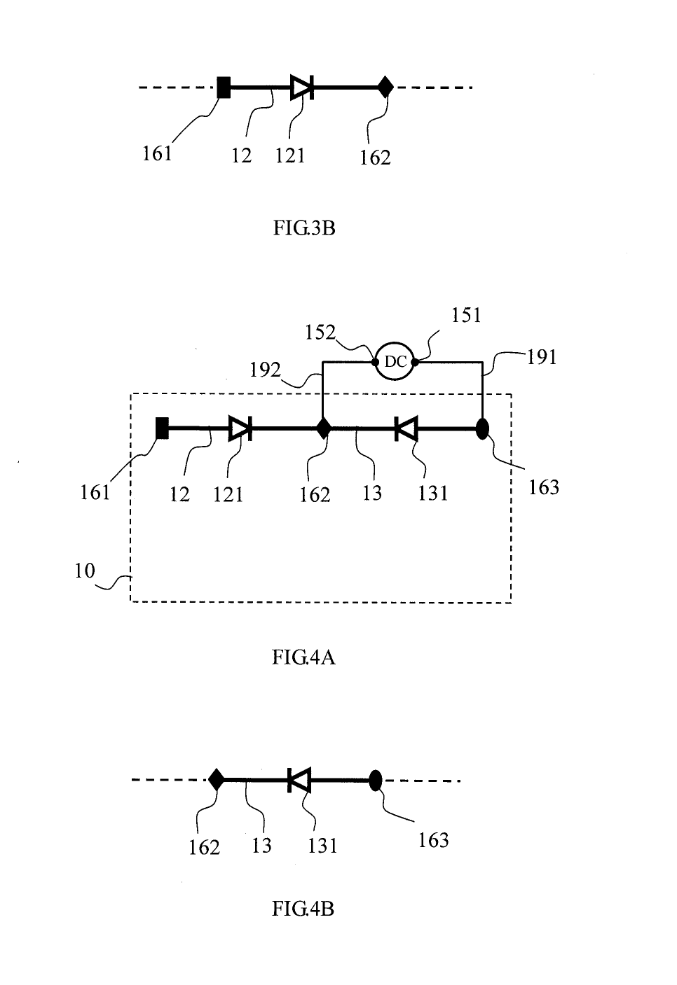

Referring to FIG. 3A and FIG. 4A, in another embodiment, the first conductive layer 161 or the third conductive layer 163 is connected to a first contact 151 of an external power supply via a wire 191, and the second conductive layer 162 is connected to a second contact 152 of the external power supply via another wire 192. After the external power supplies the current, the current flows into the first light-emitting unit 121 or the second light-emitting unit 131 from the first contact 151, and then flows out from the second conductive layer 162 so the first light-emitting unit 121 or the second light-emitting unit 131 emits light. FIGS. 3B and 4B are the corresponding circuit diagrams of FIGS. 3A and 4A, respectively. In the embodiment shown in FIG. 3A, the areas of the first conductive layer 161 and the second conductive layer 162 should be large enough for accommodating the wire 191 and the wire 192 thereon by wire bonding.

Referring to FIG. 5, a circuit diagram corresponding to an array-type light-emitting device 210 is disclosed. The light-emitting device 210 includes an insulating carrier 10; a first light-emitting circuit element 12 including a first light-emitting unit 121 formed on the insulating carrier 10, wherein the first light-emitting circuit 12 is a one-way circuit; a second light-emitting circuit 13 including a second light-emitting unit 131 formed on the insulating carrier 10, wherein the second light-emitting circuit 13 is a one-way circuit; a third light-emitting circuit 24 including a third light-emitting unit 241 formed on the insulating carrier 10, wherein the third light-emitting circuit 24 is a one-way circuit; a first conductive layer 161 formed on the insulating carrier 10; a second conductive layer 162 formed on the insulating carrier 10; a third conductive layer 163 formed on the insulating carrier 10; a forth conductive layer 264 formed on the insulating carrier 10; wherein the first light-emitting circuit 12 is formed between the first conductive layer 161 and the second conductive layer 162 and connects with them electrically by lithography etching or wire bonding. The second light-emitting circuit 13 is formed between the second conductive layer 162 and the third conductive layer 163 and connects with them electrically by conductive films or wires, and the third light-emitting circuit 24 is formed between the second conductive layer 162 and the forth conductive layer 264 and connects with them electrically, wherein the area of the forth conductive layer 264 is 3.8×10³ μm². The light-emitting device 210 can be connected to an external power supply by wire bonding for serially connecting to a circuit based on the demands of a user, and the details are disclosed in the following description.

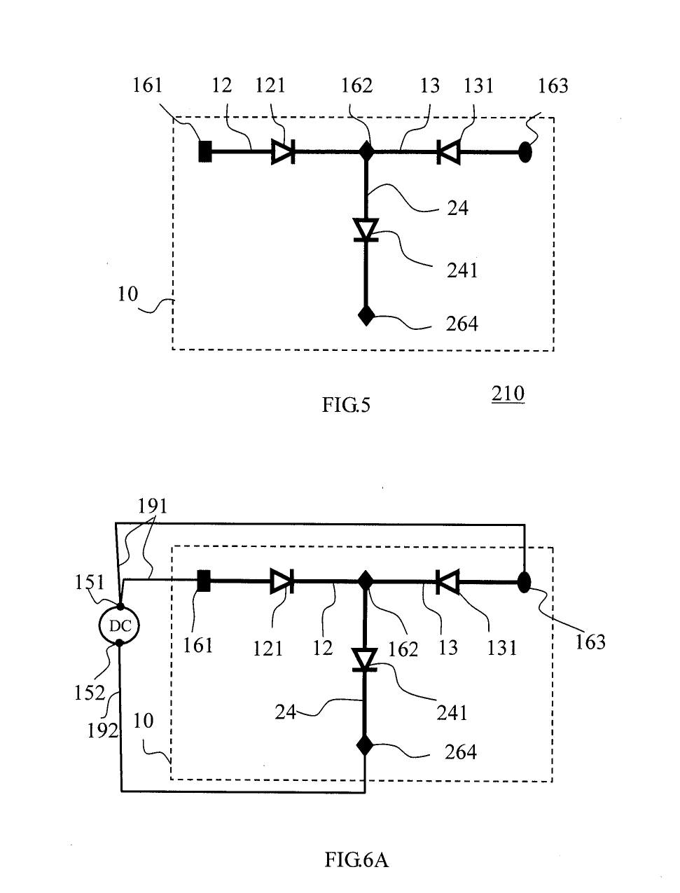

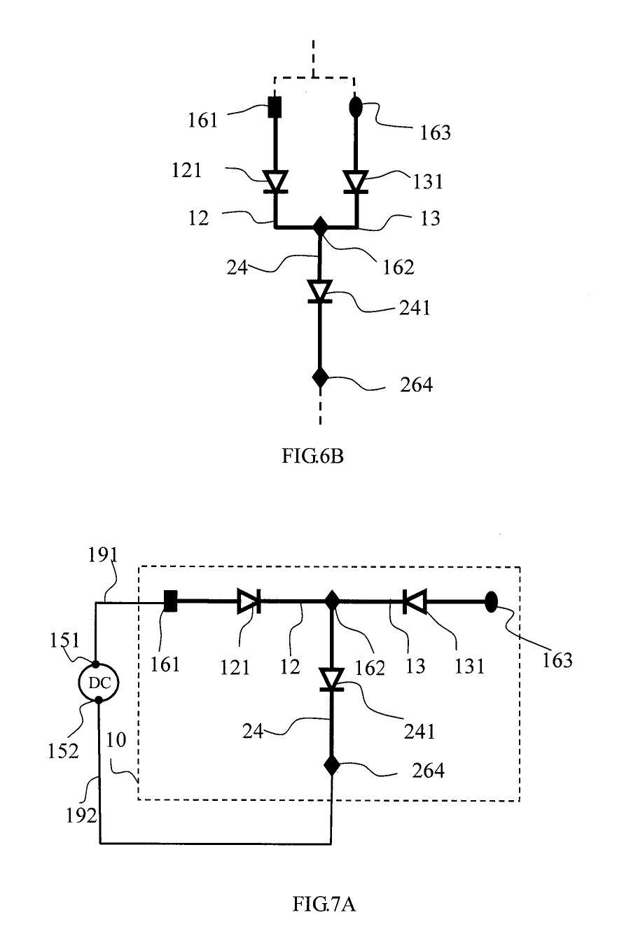

Referring to FIGS. 6A and 6B, the light-emitting device 210 can form a light-emitting circuit by serially connecting the conductive layers of the light-emitting device 210 based on the need of the users. In the present embodiment, the direction of the first light-emitting unit 12 is from the first conductive layer 161 to the second conductive layer 162; the direction of the second light-emitting unit 13 is from the third conductive layer 163 to the second conductive layer 162; the direction of the third light-emitting unit 24 is from the second conductive layer 162 to the forth conductive layer 264. The first conductive layer 161 and the third conductive layer 163 is respectively connected to a first contact 151 of an external power supply via a wire 191, and the forth conductive layer 264 is connected to a second contact 152 of the external power supply via another wire 192. After the current is supplied from the external power supply, the current flows into the first light-emitting unit 121 and the second light-emitting unit 131 from the first contact 151, and then flows out from the second conductive layer 162, therefore forming a parallel connection having the first light-emitting unit 121 and the second light-emitting unit 131, and the parallel connection is serially connected to the third light-emitting unit 241, so the first light-emitting unit 121, the second light-emitting unit 131 and the third light-emitting unit 241 emit light. FIG. 6B is the corresponding circuit diagram of the present embodiment.

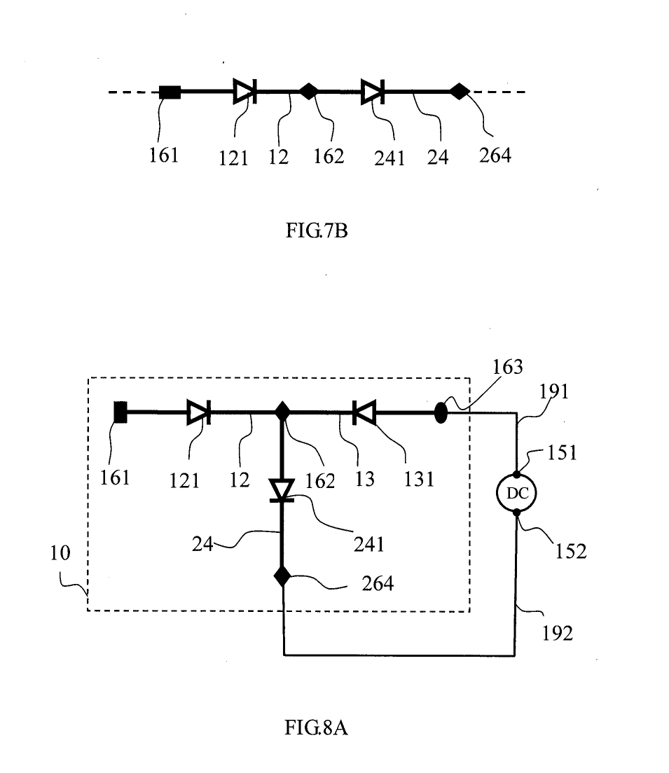

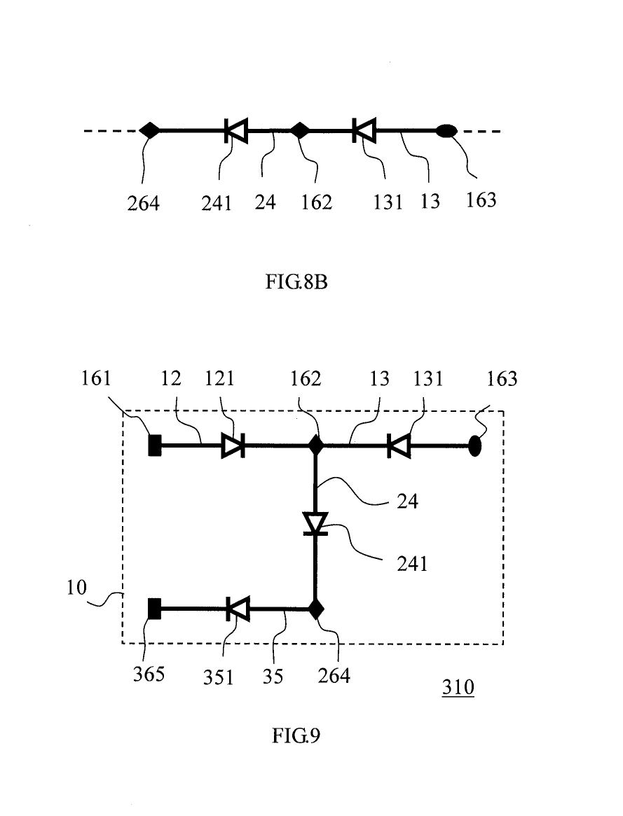

Referring to FIG. 7A and FIG. 8A, in another embodiment, the first conductive layer 161 and the third conductive layer 163 is respectively connected to a first contact 151 of the external power supply via a wire 191, and the forth conductive layer 264 is connected to a second contact 152 of the external power supply via another wire 192. After the external power supply supplies the current, the current flows into the first light-emitting unit 121 or the second light-emitting unit 131 from the first contact 151, and then flows through the second conductive layer 162 and the third light-emitting unit 241, and finally flows out from the forth conductive 264, so the first light-emitting unit 121 and the third light-emitting unit 241, or the second light-emitting unit 131 and the third light-emitting unit 241 emit light. The FIG. 7B and FIG. 8B are the corresponding circuit diagram of FIG. 7A and FIG. 8A.

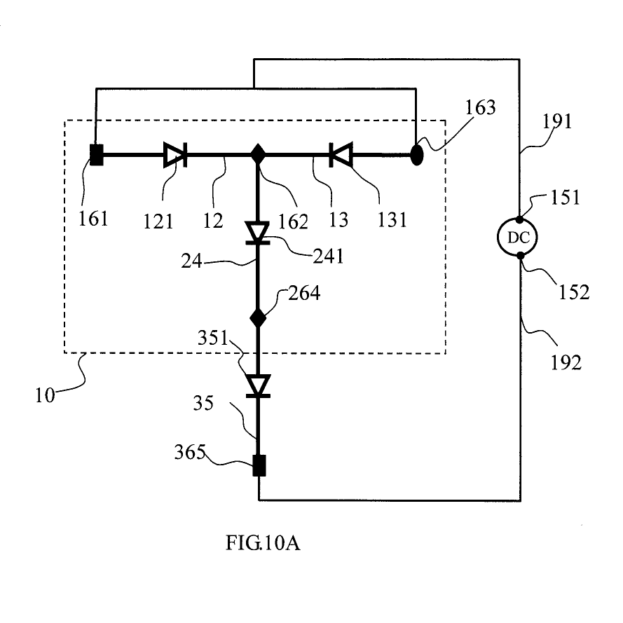

Referring to FIG. 9, a schematic circuit diagram corresponding to the array-type light-emitting device 310 of a third embodiment of the present application includes an insulating carrier 10; a first light-emitting circuit element 12 including a first light-emitting unit 121 formed on the insulating carrier 10, wherein the first light-emitting circuit 12 is a one-way circuit; a second light-emitting circuit 13 including a second light-emitting unit 131 formed on the insulating carrier 10, wherein the second light-emitting circuit 13 is a one-way circuit; a third light-emitting circuit 24 including a third light-emitting unit 241 formed on the insulating carrier 10, wherein the third light-emitting circuit 24 is a one-way circuit; a forth light-emitting circuit 35 including a forth light-emitting unit 351 formed on the insulating carrier 10, wherein the forth light-emitting circuit 35 is a one-way circuit; a first conductive layer 161, a second conductive layer 162, a third conductive layer 163, a forth conductive layer 264, and a fifth conductive layer 365 are formed on the insulating carrier 10, respectively; wherein the first light-emitting circuit 12 is formed between the first conductive layer 161 and the second conductive layer 162 and connects with them electrically, the second light-emitting circuit 13 is formed between the second conductive layer 162 and the third conductive layer 163 and connects with them electrically, the third light-emitting circuit 24 is formed between the second conductive layer 162 and the forth conductive layer 264 and connects with them electrically, the forth light-emitting circuit 35 is formed between the forth conductive layer 264 and the fifth conductive layer 365 and connects with them electrically; wherein the area of the fifth conductive layer 365 is 3.8×10³ μm². The light-emitting device 310 can be connected to an external power supply by wire bonding for serially connecting to a circuit based on the demands of a user, and the details are disclosed in the following description.

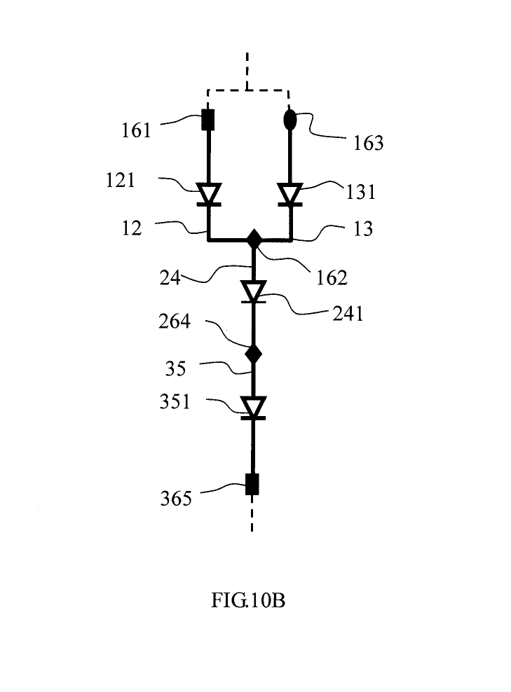

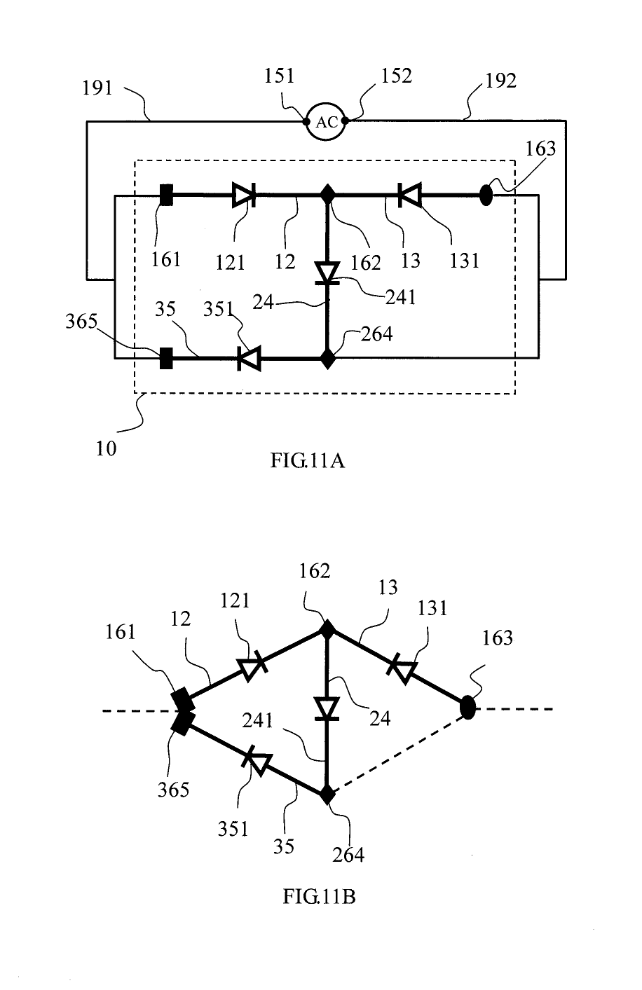

Referring to FIG. 10A and FIG. 10B, the light-emitting device 310 can form a light-emitting circuit by serially connecting the conductive layers of the light-emitting device 210 based on the need of the users. In the present application, the direction of the first light-emitting unit 12 is from the first conductive layer 161 to the second conductive layer 162; the direction of the second light-emitting unit 13 is from the third conductive layer 163 to the second conductive layer 162; the direction of the third light-emitting unit 24 is from the second conductive layer 162 to the forth conductive layer 264; the direction of the forth light-emitting unit 35 is from the forth conductive layer 264 to the fifth conductive layer 365. The first conductive layer 161 and the third conductive layer 163 are respectively connected to a first contact 151 of an external power supply via a wire 191; the fifth conductive layer 365 is connected to a second contact 152 of the external power supply via another wire 192. After the external power supply supplies the current, the current flows into the first light-emitting unit 121 and the second light-emitting unit 131 from the first contact 151, and then flows through the second conductive layer 162, the third light-emitting unit 241 of the third light-emitting circuit 24, the forth conductive layer 264, the forth light-emitting unit 351 of the forth light-emitting circuit 35, and flows out from the fifth conductive layer 365, therefore forming a circuit design including a parallel connection formed by the first light-emitting unit 121 and the second light-emitting unit 131, and a serial connection formed by the third light-emitting unit 241 and the forth light-emitting unit 351. FIG. 10B is the corresponding circuit diagram of the present embodiment.

Referring to FIG. 11A and FIG. 11B, in another embodiment, the first conductive layer 161 and the fifth conductive layer 365 is respectively connected to a first contact 151 of an external power supply via a wire 191; the third conductive layer 163 and the forth conductive layer 264 is respectively connected to a second contact 152 of the external power supply via another wire 192. After the AC power supply supplies the forward current, the current flows into the first light-emitting unit 121 from the first contact 151, then flows through the second conductive layer 162, the third light-emitting unit 241 of the third light-emitting circuit 24, and flows out from the forth conductive layer 264. When the AC power supply supplies the reverse current, the current flows into the second light-emitting unit 131 from the second contact 152; then flows through the second conductive layer 162, the third light-emitting unit 241 of the third light-emitting circuit 24, the forth conductive layer 264, the forth light-emitting unit 351 of the forth light-emitting circuit 35, and finally flows out from the fifth conductive layer 365. An AC circuit is formed as shown in FIG. 11B.

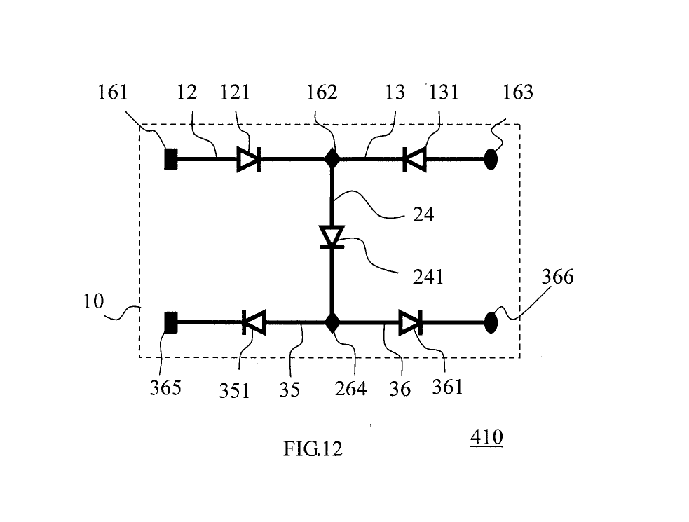

Referring to FIG. 12, a schematic circuit diagram in accordance with the array-type light-emitting device 410 of a forth embodiment of the present application includes an insulating carrier 10; a first light-emitting circuit element 12 including a first light-emitting unit 121 formed on the insulating carrier 10, wherein the first light-emitting circuit 12 is a one-way circuit; a second light-emitting circuit 13 including a second light-emitting unit 131 formed on the insulating carrier 10, wherein the second light-emitting circuit 13 is a one-way circuit; a third light-emitting circuit 24 including a third light-emitting unit 241 formed on the insulating carrier 10, wherein the third light-emitting circuit 24 is a one-way circuit; a forth light-emitting circuit 35 including a forth light-emitting unit 351 formed on the insulating carrier 10, wherein the forth light-emitting circuit 35 is a one-way circuit; a fifth light-emitting circuit 36 including a fifth light-emitting unit 361 formed on the insulating carrier 10, wherein the fifth light-emitting circuit 36 is a one-way circuit; a first conductive layer 161, a second conductive layer 162, a third conductive layer 163, a forth conductive layer 264, a fifth conductive layer 365, and a sixth conductive layer 366 are formed on the insulating carrier 10, respectively; wherein the first light-emitting circuit 12 is formed between the first conductive layer 161 and the second conductive layer 162 and connects with them electrically, the second light-emitting circuit 13 is formed between the second conductive layer 162 and the third conductive layer 163 and connects with them electrically, the third light-emitting circuit 24 is formed between the second conductive layer 162 and the forth conductive layer 264 and connects with them electrically, the forth light-emitting circuit 35 is formed between the forth conductive layer 264 and the fifth conductive layer 365 and connects with them electrically, the fifth light-emitting circuit 36 is formed between the forth conductive layer 264 and the sixth conductive layer 366 and connects with them electrically; wherein the areas of the fifth conductive layer 365 and the sixth conductive layer 366 are 3.8×10³ μm². The light-emitting device 410 can be connected to an external power supply by wire bonding for serially connecting to a circuit based on the demands of a user. The detail descriptions are as follows.

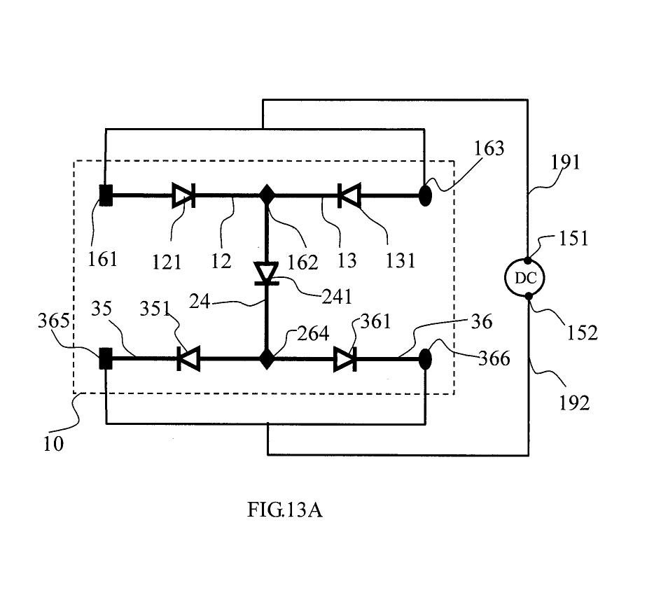

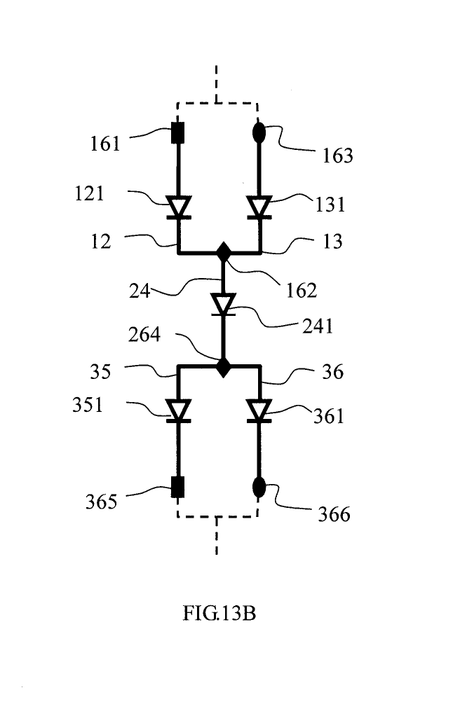

Referring to FIG. 13A and FIG. 13B, the light-emitting device 410 can form a light-emitting circuit for a user by serially connecting the conductive layers of the light-emitting device 410. In the present application, the direction of the first light-emitting unit 12 is from the first conductive layer 161 to the second conductive layer 162; the direction of the second light-emitting unit 13 is from the third conductive layer 163 to the second conductive layer 162; the direction of the third light-emitting unit 24 is from the second conductive layer 162 to the forth conductive layer 264; the direction of the forth light-emitting unit 35 is from the forth conductive layer 264 to the fifth conductive layer 365; the direction of the fifth light-emitting unit 36 is from the forth conductive layer 264 to the sixth conductive layer 366. The first conductive layer 161 and the third conductive layer 163 are respectively connected to a first contact 151 of an external power supply via a wire 191; the fifth conductive layer 365 and sixth conductive layer 366 are respectively connected to a second contact 152 of the external power supply via another wire 192. After the external power supply supplies the current, the current respectively flows into the first light-emitting unit 121 and the second light-emitting unit 131 from the first contact 151, and then flows through the second conductive layer 162, the third light-emitting unit 241 of the third light-emitting circuit 24, the forth conductive layer 264, and respectively flows through the forth light-emitting unit 351 of the forth light-emitting circuit 35 and the fifth light-emitting unit 361 of the fifth light-emitting circuit 36, and finally flow out from the fifth conductive layer 365 and the sixth conductive layer 366. A circuit design having the first light-emitting unit 121 and the second light-emitting unit 131 connected in parallel, and the third light-emitting unit 241 and the forth light-emitting unit 351 connected in series is formed. FIG. 13B is the corresponding circuit diagram of the present embodiment.

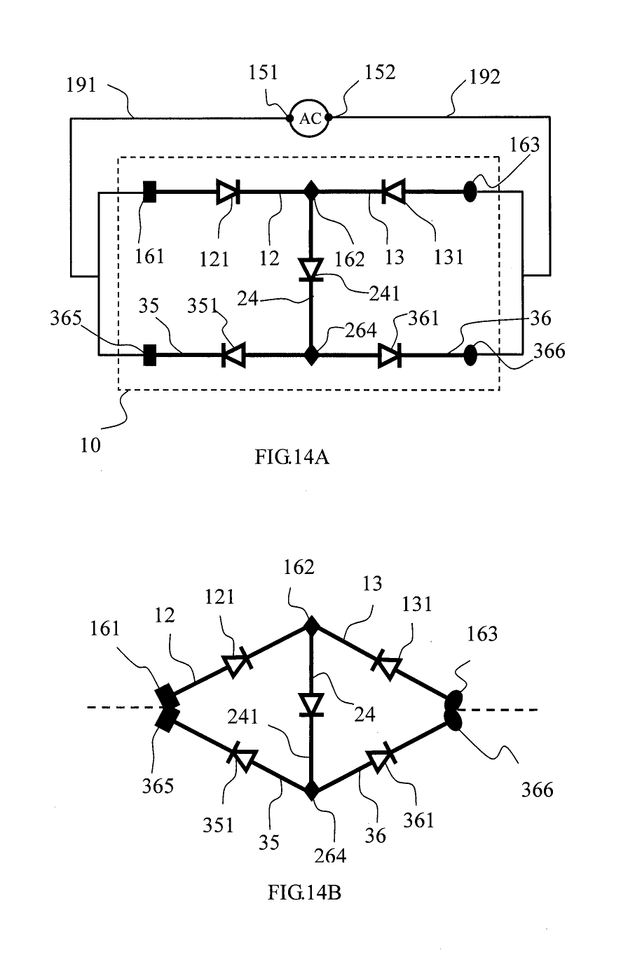

Referring to FIG. 14A and FIG. 14B, in another embodiment, the first conductive layer 161 and the fifth conductive layer 365 are respectively connected to a first contact 151 of an external power supply via a wire 191; the third conductive layer 163 and the sixth conductive layer 366 are respectively connected to a second contact 152 of the external power supply via another wire 192. After the external power supplies the forward current, the current flows into the first light-emitting unit 121 from the first contact 151, and then flows through the second conductive layer 162, the third light-emitting unit 241 of the third light-emitting circuit 24, the forth conductive layer 264, the fifth light-emitting unit 361 of the fifth light-emitting circuit 36, and finally flow out from the sixth conductive layer 366. When the external power supplies the reverse current, the current flows into the second light-emitting unit 131 from the first contact 152, and then flows through the second conductive layer 162, the third light-emitting unit 241 of the third light-emitting circuit 24, the forth conductive layer 264, the forth light-emitting unit 351 of the forth light-emitting circuit 35, and finally flows out from the fifth conductive layer 365. An AC circuit is formed as shown in FIG. 14B.

Referring to FIG. 15, in the present embodiment of the light-emitting device of the AC bridge circuit, the wire 191 for connecting the first conductive layer 161 and the fifth conductive layer 365 can be neglected and replaced by a bonding pad 391. Similarly, the wire 192 for connecting the third conductive layer 163 and the sixth conductive layer 366 can be neglected and replaced by a bonding pad 392. Referring to the circuit design as shown in FIG. 15, on the insulating carrier 10, the first conductive layer 161 is designed to be adjacent to the fifth conductive layer 365, and a preferred distance therebetween allows the bonding pad 391 to be simultaneously formed on both of them Similarly, the a preferred distance between the third conductive layer 163 and the sixth conductive layer 366 allows the bonding pad 392 to be simultaneously formed on both of them.

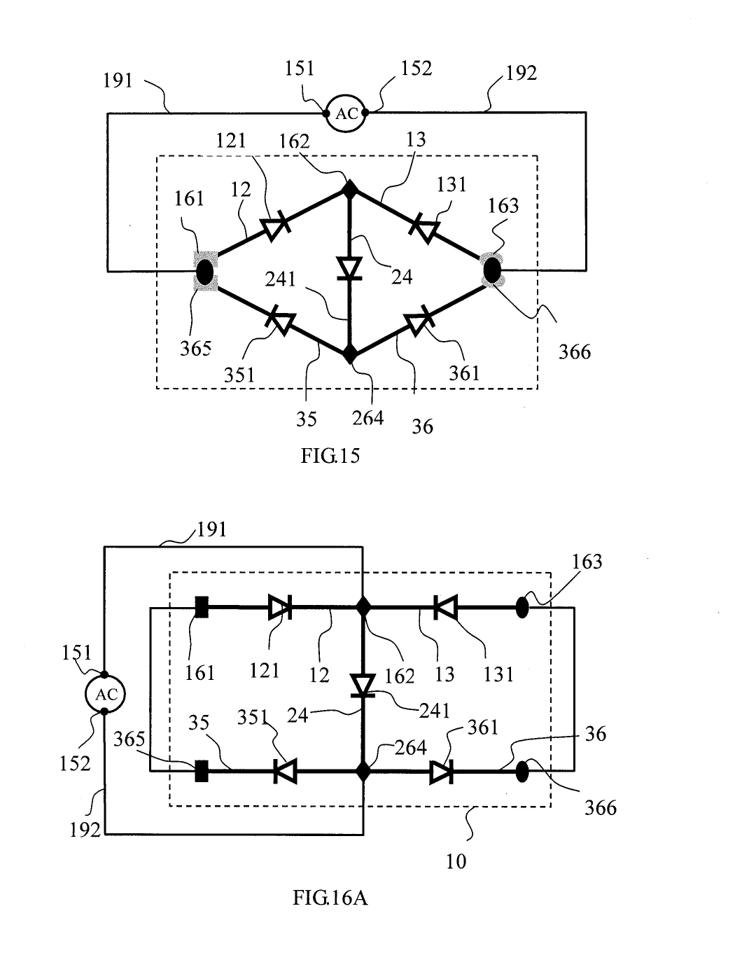

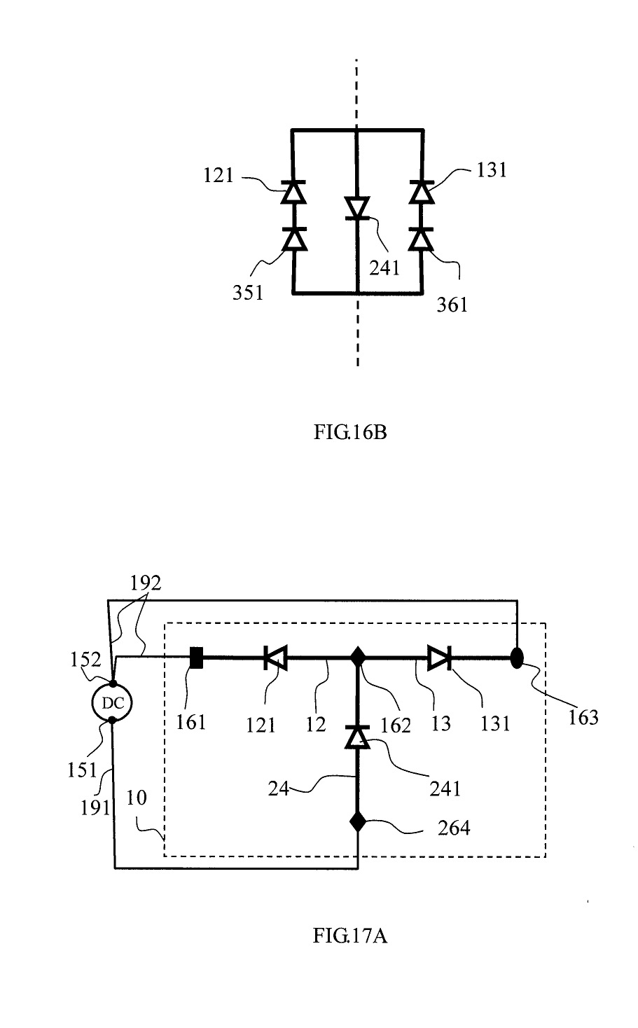

Referring to FIG. 16A and FIG. 16B, in another embodiment, the first conductive layer 161 and the fifth conductive layer 365 are connected via a wire 193; the third conductive layer 163 and the sixth conductive layer 366 are connected via another wire 194; the second conductive layer 162 is connected to a first contact 151 of an external power supply via a wire 191; the forth conductive layer 264 is connected to a second contact 152 of an external power supply via a wire 192. After the AC power supplies the current and when the current is a forward current, the current flows from the first contact 151, and then flows through the second conductive layer 162 into the third light-emitting unit 241, and finally flows out from the forth conductive layer 264; when the current is a reverse current, the current flows from the second contact 152 to pass through the forth conductive layer 264, and then splits to two current, wherein the first split current flows into the forth light-emitting unit 351 of the forth light-emitting circuit 35, and then flows through the five conductive layer 365 into the first conductive layer 161 via the wire 193, and then flows into the first light-emitting unit 121 of the first light-emitting circuit 12, and finally flows out from the second conductive layer 162; the second split current flows into the fifth light-emitting 361 of the fifth light-emitting circuit, and then flows through the sixth conductive 366, into the third conductive layer 163 via the wire 194, and then flows into the second light-emitting unit 131 of the second light-emitting circuit, and finally flows out from the second conductive layer 162. From the circuit diagram shown in FIG. 16B, an anti-parallel AC circuit design is disclosed.

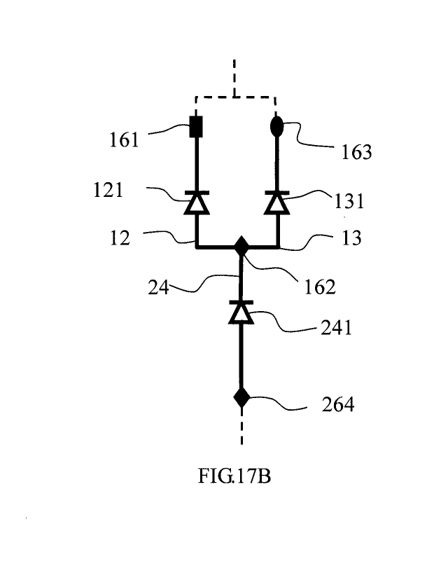

The light-emitting circuit of the aforesaid embodiments can be reversed simultaneously, and the directions of the circuits are reversed in any of the aforesaid embodiments, and the direction of the DC power supplies are reversed as well. Taking the second embodiment for example, and referring to FIG. 17A and FIG. 17B, it is known that when the direction of the light-emitting circuit is changed, the direction of the first light-emitting circuit 12 is from the second conductive layer 162 to the first conductive layer 161; the direction of the second light-emitting circuit 13 is from the second conductive layer 162 to the third conductive layer 163; the direction of the third light-emitting circuit 24 is from the forth conductive layer 264 to the second conductive layer 162. The first conductive layer 161 and the third conductive layer 163 are respectively connected to a second contact 152 of an external power supply via a wire 192, and the forth conductive layer 264 is connected to a first contact 151 of the external power supply via a wire 191. After the external power supply supplies the current, the current flows into the third light-emitting unit 241 from the first contact 151, and then flows out from the second conductive layer 162 to flow into the first light-emitting unit 121 and the second light-emitting unit 131. FIG. 17B is the corresponding circuit diagram of the present embodiment.

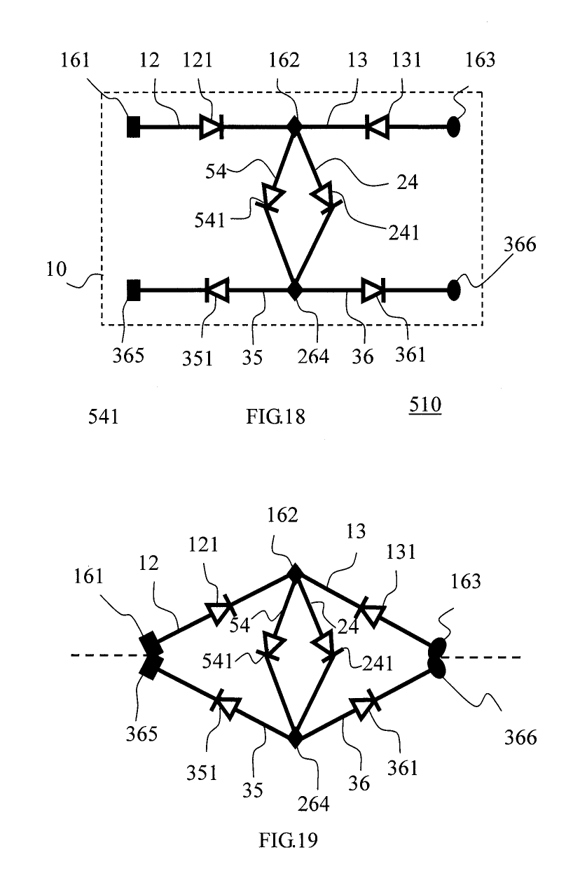

Referring to FIG. 18, a schematic circuit diagram in accordance with an array-type light-emitting device 510 of a fifth embodiment of the present application is disclosed. The structure of the light-emitting device 510 is similar to the light-emitting device 410. The light-emitting device 510 includes an insulating carrier 10; a first light-emitting circuit 12 including a first light-emitting unit 121 formed on the insulating carrier 10, wherein the first light-emitting circuit 12 is a one-way circuit; a second light-emitting circuit 13 including a second light-emitting unit 131 formed on the insulating carrier 10, wherein the second light-emitting circuit 13 is a one-way circuit; a third light-emitting circuit 24 including a third light-emitting unit 241 formed on the insulating carrier 10, wherein the third light-emitting circuit 24 is a one-way circuit; a forth light-emitting circuit 35 including a forth light-emitting unit 351 formed on the insulating carrier 10, wherein the forth light-emitting circuit 35 is a one-way circuit; a fifth light-emitting circuit 36 including a fifth light-emitting unit 361 formed on the insulating carrier 10, wherein the fifth light-emitting circuit 36 is a one-way circuit; a first conductive layer 161, a second conductive layer 162, a third conductive layer 163, a forth conductive layer 264, a fifth conductive layer 365, and a sixth conductive layer 366 are formed on the insulating carrier 10, respectively; wherein the first light-emitting circuit 12 is formed between the first conductive layer 161 and the second conductive layer 162 and connects with them electrically, the second light-emitting circuit 13 is formed between the second conductive layer 162 and the third conductive layer 163 and connects with them electrically, the third light-emitting circuit 24 is formed between the second conductive layer 162 and the forth conductive layer 264 and connects with them electrically, the forth light-emitting circuit 35 is formed between the forth conductive layer 264 and the fifth conductive layer 365 and connects with them electrically; the fifth light-emitting circuit 36 is formed between the forth conductive layer 264 and the sixth conductive layer 366 and connects with them electrically; wherein the areas of the fifth conductive layer 365 and the sixth conductive layer 366 are 3.8×10³ μm². The difference between the light-emitting device 510 and the light-emitting device 410 is that in light-emitting device 510 further includes a sixth light-emitting circuit 54 formed between the second conductive layer 162 and the forth conductive layer 264. The sixth light-emitting circuit 54 includes a sixth light-emitting unit 541 formed on the insulating carrier 10, wherein the sixth light-emitting circuit 54 is a one-way circuit, and formed between the second conductive layer 162 and the forth conductive layer 264 and connects with them electrically, and is connected in parallel with the third light-emitting circuit 24.

In the above embodiments, the method for electrically connecting each light-emitting circuit including forming a conductive film including metal, or metal oxide such as ITO, ZnO or InO on the carrier by coating, and then defining the locations of the conductive films by lithography and/or etching so the conductive films contact the light-emitting units of the light-emitting circuit and the conductive layer respectively. An insulating film can be firstly formed on at least the sidewalls of the light-emitting unit and formed under the conductive film before forming the conductive film so the damages due to the short circuit on the light-emitting unit can be avoided. Another method for forming the electrical connection is that forming a wire bonding pad on the light-emitting unit in advance, and attaching the wires on the wire bonding pad and the conductive layer respectively, wherein the area of the conductive layer must be great enough for accommodating the wires of wire bonding process.

The circuit design of the light-emitting device 510 of the present embodiment is similar to that of the light-emitting device 410, and when the external power supply is an AC power supply, a bridge-type circuit is formed in one embodiment as shown in FIG. 19. The bridge circuit can be formed in parallel connection by electrically connecting the third light-emitting circuit 24 and the sixth light-emitting circuit 54 between the second conductive layer 162 and the forth conductive layer 264. When a external AC power is connected to the bridge-type circuit, the circuit between the second conductive layer 162 and the forth conductive 264 is conductive under both forward and reverse currents, so that the current loading of the third light-emitting unit 241 and the sixth light-emitting unit 541 can be lowered by connecting both in parallel, therefore the operation life of the third light-emitting unit 241 and the sixth light-emitting unit 541 can be close to that of other light-emitting units.

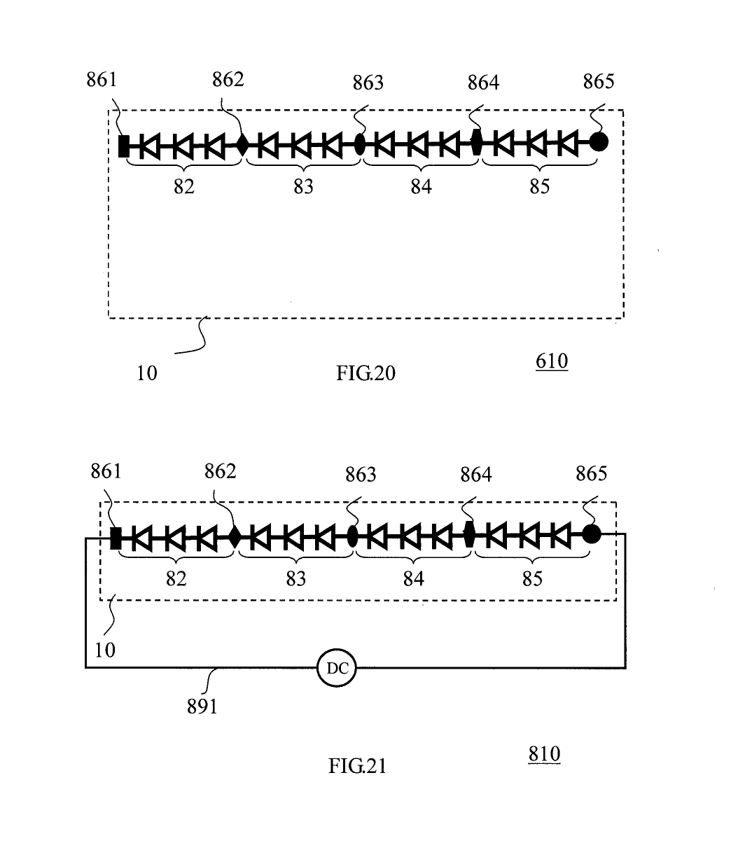

Referring to FIG. 20, a schematic circuit diagram in accordance with the array-type light-emitting device 610 of a sixth embodiment of the present application is disclosed. The structure of the light-emitting device 610 includes an insulating carrier 10; a first light-emitting circuit 82 including multiple first light-emitting units formed on the insulating carrier 10; a second light-emitting circuit 83 including multiple second light-emitting units formed on the insulating carrier 10; a third light-emitting circuit 84 including multiple third light-emitting units on the insulating carrier 10; a forth light-emitting circuit 85 including multiple forth light-emitting units formed on the insulating carrier 10; a fifth light-emitting circuit 865 including multiple fifth light-emitting units formed on the insulating carrier 10; a first conductive layer 861, a second conductive layer 862, a third conductive layer 863, a forth conductive layer 864, and a fifth conductive layer 865 are formed on the insulating carrier 10, respectively; wherein the first light-emitting circuit 82 is formed between the first conductive layer 861 and the second conductive layer 862, the second light-emitting circuit is formed between the second conductive layer 862 and the third conductive layer 863, the third light-emitting circuit is formed between the second conductive layer 162 and the forth conductive layer 264, the forth light-emitting circuit is formed between the forth conductive layer 864 and the fifth conductive layer 865. Each light-emitting unit of the light-emitting circuits is serially connected to a one-way circuit. The conductive layers are capable for wire bonding with the areas enough for attaching the wires connected to an external power supply. In the embodiment, the areas of each conductive layer are 3.8×10³ μm².

Referring to FIG. 21, in the array-type light-emitting device 610, a first circuit design including four light-emitting circuits connected in series by a wire 891 connecting the first conductive layer 861 and the fifth conductive layer 865 to a DC power supply.

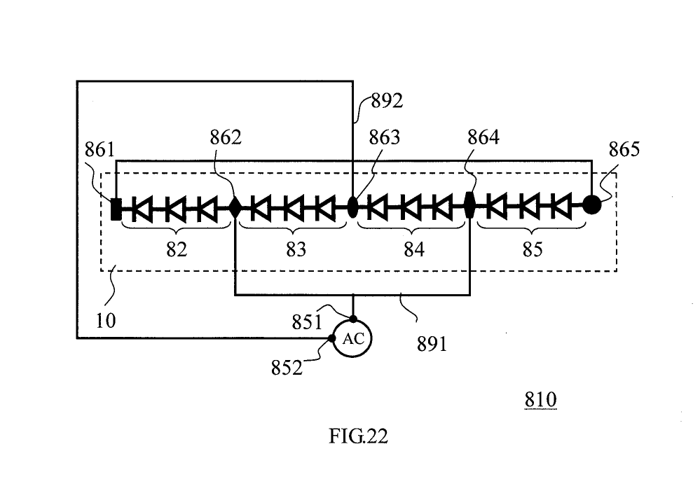

Referring to FIG. 22, in the array-type light-emitting device 610, an AC circuit design of the light-emitting device is formed by connecting the second conductive layer 862 and the forth conductive 864 to a first contact 851 of an AC power supply via a first wire 891, and connecting the first conductive layer 861, the third conductive layer 863 and fifth conductive layer 865 to a second contact of an AC power supply.

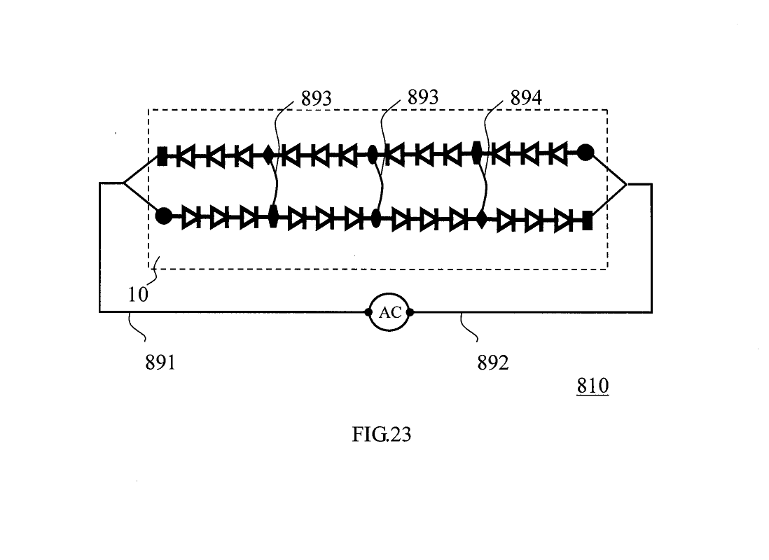

Referring to FIG. 23, on the insulating carrier, a second circuit group can be formed by including the first light-emitting circuit 82, the second light-emitting circuit 83, the third light-emitting circuit 84, the forth light-emitting circuit 85, the first conductive layer 861, the second conductive layer 862, the third conductive layer 863, the forth conductive layer 864, and the fifth conductive layer 865. The circuit group of the light-emitting device is formed by connecting the second conductive layer 862 of the first circuit group to the forth conductive layer 864 of the second circuit group via a third wire 893; connecting the third conductive layer 863 of the first circuit group to the third conductive layer 863 of the second circuit group via a forth wire 894; connecting the forth conductive layer 864 of the first circuit group to the second conductive layer 862 of the second circuit group via a fifth wire 895; connecting the first conductive layer 861 of the first circuit group and the fifth conductive layer 865 of the second circuit group to a first contact 851 of a external AC power supply via a first wire 891; connecting the fifth conductive layer 865 of the first circuit group and the first conductive layer 861 of the second circuit group to a second contact 852 of the external AC power supply via a second wire 892. The circuit group can be applied to an anti-parallel array-type light-emitting device, and when the light-emitting device is directly driven by an AC power supply and there are few defective light-emitting units in the light-emitting circuit, the risk of overall breakdown in reverse voltage phase caused by the few defective light-emitting units can be avoided.

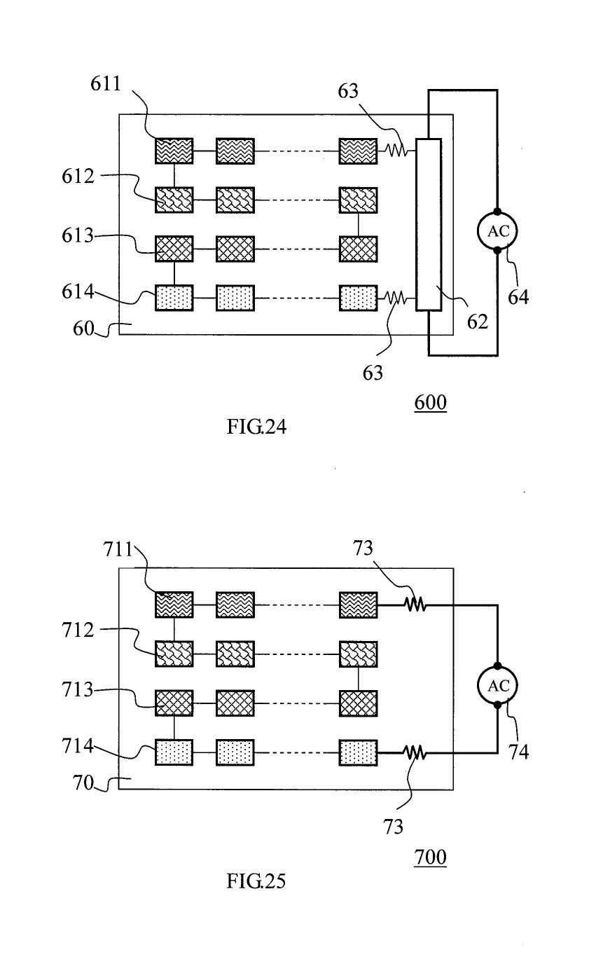

In the aforesaid embodiments, the lights emitted from each light-emitting unit of the light-emitting device can have the same wavelength or different wavelengths when the light-emitting device having light-emitting units formed by wafer bonding. Each light-emitting device can be packaged to be a light source of single wavelength or a light source of color-mixing. Referring to FIG. 24, a schematic diagram of a package of an array-type light-emitting device of an embodiment of the present application is disclosed. The package structure includes a first light-emitting device 611 emitting red light; a second light-emitting device 612 emitting blue light; a third light-emitting device 613 emitting green light; and a forth light-emitting device 614 emitting yellow light. Each light-emitting unit is disposed on a package substrate 60. The internal circuit of each light-emitting unit is a DC circuit, the external power supply is an AC power supply 64, so that the package substrate 60 contains a rectification device 62 to switch the alternating current to the direct current for operating each light-emitting unit and an electric resistance 63. The rectification device 62 and the electric resistance 63 are connected to the light-emitting device in series. The forth light-emitting device 614 emitting yellow light is formed by spreading adhesive glue mixed with yellow phosphor on the outside surface of light-emitting diode. When the light-emitting diode is driven to emit blue light or purple light, the yellow phosphor is activated to emit yellow light for mixing color with red, green, and blue light of the first light-emitting device 611 emitting red light, the second light-emitting 612 emitting blue light, the third light-emitting 613 emitting green light to generate white light. The light-emitting device 611, 612, 613, and 614 can be multiple and disposed on the package substrate 60.

Referring to FIG. 25, a schematic diagram of an array-type light-emitting device in accordance with an embodiment of the present application is disclosed. The package structure includes a first light-emitting device 711 emitting red light; a second light-emitting device 712 emitting blue light; a third light-emitting device 713 emitting green light; and a forth light-emitting device 714 emitting yellow light. Each light-emitting device is disposed on a package substrate 70. The internal circuit of each light-emitting device is for AC power as shown in FIG. 14B or FIG. 19, and the external power supply 74 is an AC power supply serially connected to the light-emitting device. A passive element, such as an electric resistance 73 is further included between the AC power supply 74 and the light-emitting device. The forth light-emitting device 714 emitting yellow light is formed by spreading adhesive glue mixed with yellow phosphor on the outside of light-emitting diode. When the light-emitting diode is driven to emit blue light or purple light, and then the yellow phosphor is activated to emit yellow light for mixing color with red, green, and blue light of the first light-emitting device 711 emitting red light, the second light-emitting 712 emitting blue light, the third light-emitting 713 emitting green light to emit white light. The light-emitting device 711, 712, 713, and 714 can be multiple and disposed on the package substrate 70.

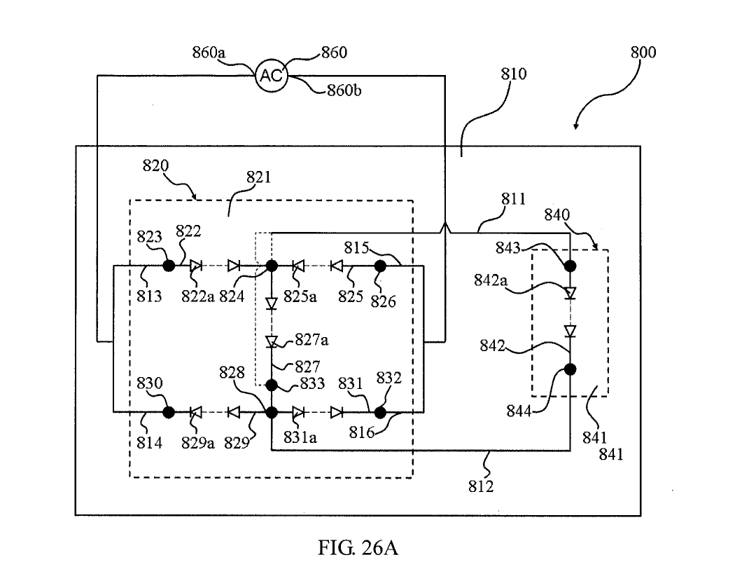

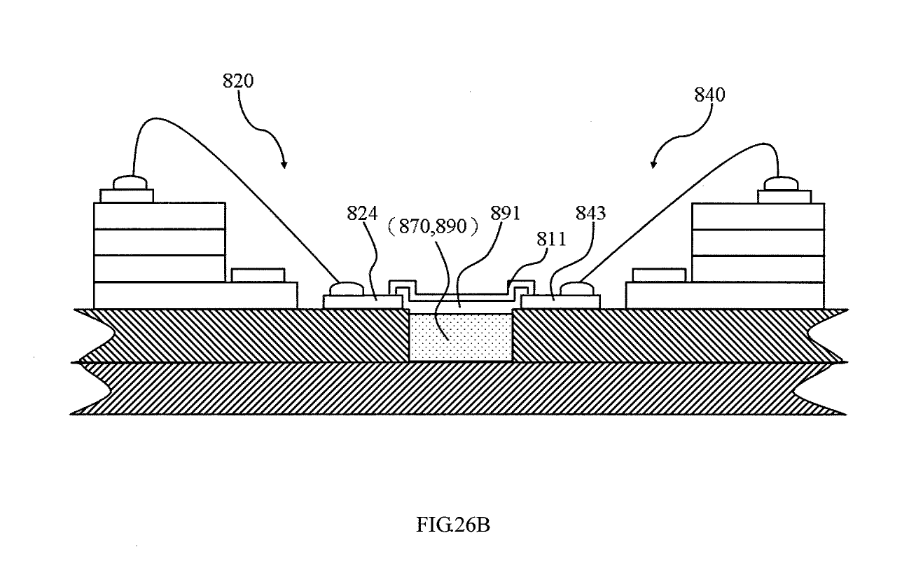

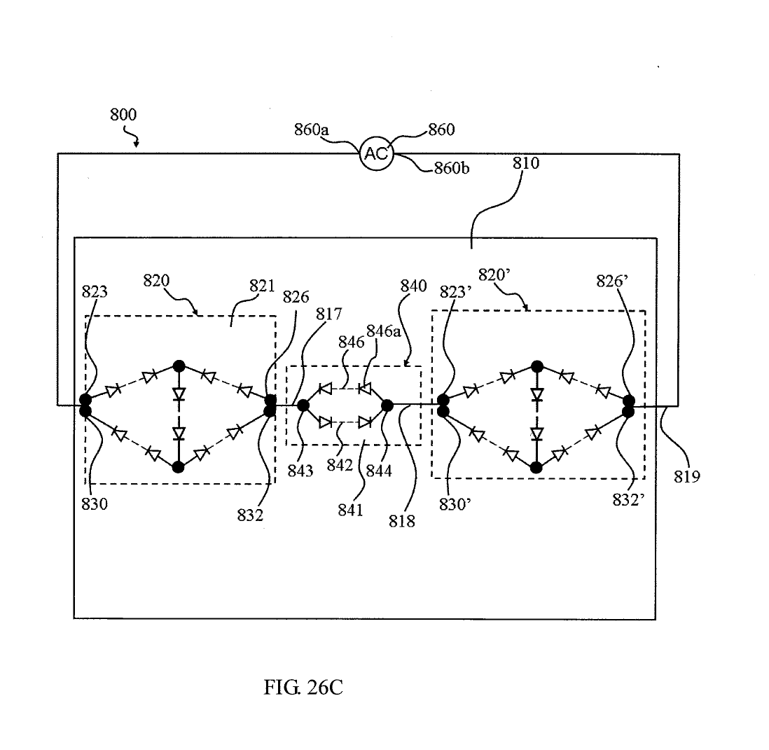

Referring to FIG. 26A, a schematic diagram of circuit of a light-emitting module of an embodiment of the present application is disclosed. A light-emitting module 800 includes a carrier 810, a first light-emitting device 820 disposed on the carrier 810, and a second light-emitting device 840 disposed on the carrier 810. The carrier 810 can be a sub-mount for disposing multiple light-emitting devices, and the sub-mount can be a lead frame or mounting substrate. As to the present embodiment, the first light-emitting device 820 and second light-emitting device 840 are disposed on the carrier 810, and a circuit design for the two light-emitting devices can be proceeded on the carrier 810.

The first light-emitting device 820 includes a first insulating carrier 821. The first insulating carrier 821 has a first light-emitting circuit 822 thereon, and two ends of the first light-emitting circuit 822 are connected to a first conductive layer 823 and a second conductive layer 824, and the first light-emitting circuit 822 includes a first light-emitting unit 822a directed from the first conductive layer 823 to the second conductive layer 824. The first insulating carrier 821 has a second light-emitting circuit 825 thereon, and two ends of the second light-emitting circuit 825 are connected to the second conductive layer 824 and a third conductive layer 826, and the second light-emitting circuit 825 includes at least a second light-emitting unit 825a directed from the third conductive layer 826 to the second conductive layer 824. The first insulating carrier 821 has a third light-emitting circuit 827 thereon, and two ends of the third light-emitting circuit 827 are connected to the second conductive layer 824 and a forth conductive layer 828, and the third light-emitting circuit 827 includes a third light-emitting unit 827a directed from the second conductive layer 824 to the forth conductive layer 828. The first insulating carrier 821 further has a forth light-emitting circuit 829 thereon, and two ends of the forth light-emitting circuit 829 are connected to the forth conductive layer 828 and a fifth conductive layer 830, and the forth light-emitting circuit 829 includes a forth light-emitting unit 829a directed from the forth conductive layer 828 to the fifth conductive layer 830. The first insulating carrier 821 further has a fifth light-emitting circuit 831 thereon, and two ends of the third light-emitting circuit 831 are connected to the forth conductive layer 828 and a sixth conductive layer 832, and the fifth light-emitting circuit 831 includes a fifth light-emitting unit 831a directed from the forth conductive layer 828 to the sixth conductive layer 832.

The second light-emitting device 840 includes a second insulating carrier 841. The second insulating carrier 841 has a sixth light-emitting circuit 842 thereon, and two ends of the sixth light-emitting circuit 842 are connected to a seventh conductive layer 843 and a eighth conductive layer 844, and the sixth light-emitting circuit 842 includes a sixth light-emitting unit 842a directed from the seventh conductive layer 843 to the eighth conductive layer 844.

The light-emitting module 800 can further include a light-converting material spread in the first light-emitting device 820 and/or the second light-emitting device 840, and the light-converting material can be a yellow-green phosphor distributed in the light-emitting device 800 uniformly, non-uniformly, or by way of gradually concentration-changing. The first light-emitting unit 822a, the second light-emitting unit 825a, the third light-emitting unit 827a, the forth light-emitting unit 829a, and the fifth light-emitting unit 831a of the first light-emitting device 820 are blue light-emitting units, the sixth light-emitting unit 842a is a red light-emitting unit, by mixing the three primary colors comprising red, blue, and green to form white light for illumination. Of course the emitting-colors of the first light-emitting device 820 and the second light-emitting device 840 can be exchanged.

The ratio of the working voltages of the blue light-emitting unit to the red light-emitting unit is more than about 3; the ratio of the powers of the blue light-emitting unit and the red light-emitting unit is more than about 2; and the ratio of the total emitting-area of the blue light-emitting unit and the red light-emitting unit is more than about 2.

The seventh conductive layer 843 can connect to the second conductive layer 824 via a wire 811, and the eighth conductive layer 844 can connect to the forth conductive layer 828 via a wire 812, so as to parallelly connect the sixth light-emitting circuit 842 to the third light-emitting circuit 827.

A ninth conductive layer 833 can be further disposed between the third light-emitting circuit 827 and the forth conductive layer 828, and the wire 811 connected to the seventh conductive layer 843 can be further connected to the ninth conductive layer 833, and cooperating with that the wire 812 connecting to the forth conductive layer 828, so as to serially connect the sixth light-emitting circuit 842 to the third light-emitting circuit 827.

The first conductive layer 823 and the fifth conductive layer 830 can connect to a first contact 860a of an AC power supply 860 via a wire 813 and 814, respectively; the third conductive layer 826 and the sixth conductive layer 832 can connect to a second contact 860b of an AC power supply 860 via a wire 815 and 816, respectively. The areas of the first conductive layer 823, the second conductive layer 824, the forth conductive layer 828, the fifth conductive layer 830, the third conductive layer 826, the sixth conductive layer 832, the seventh conductive layer 843, or the eighth conductive layer 844 can be greater or equal to 1.9×10³ m², and the wires 811, 812, 813, 814, 815, and 816 can be formed by wire bonding. In the preset embodiment, the area of each conductive layer can be about 3.8×10³ μm². Besides, similar to the aforesaid embodiments, the first conductive layer 823 and the fifth conductive layer 830 can be close to each other to connect to the first contact 860a of the AC power supply 860 via the same wire at the same time, and the third conductive layer 826 and the sixth conductive layer 832 can be close to each other to connect to the second contact 860b of the AC power supply 860 via the same wire at the same time.

Further referring to FIG. 26B, a channel area 870 filled with adhesive glue 890 is formed between the first light-emitting device 820 and the second light-emitting device 840, wherein the material of the adhesive glue 890 can be silicone rubber, silicone resin, flexible PU, porous PU, acrylic rubber, or the glue for chip-separating including photopolymer film or UV glue. A wire for electrically connecting between the first light-emitting device 820 and the second light-emitting device 840 can be formed by lithography and deposition processes on the adhesive glue 890. As shown in the figure, the way to form the wire 811 can firstly form a dielectric layer 891 on the channel area 870 filled with adhesive glue 890 by lithography and deposition processes, and then forming the wire 811 on the dielectric layer 891, and two ends of the wire 811 are respectively connected to the seventh conductive layer 843 and the second conductive layer 824. Similarly, the wire 812 in FIG. 26A can be either formed by lithography and deposition processes other than wire bonding process. The wire 811 and 822 can be metal lines respectively.

Referring to FIG. 26C, a light-emitting module 800 of the present embodiment can include a third light-emitting device 820′ similar to the first light-emitting device 820, and a seventh light-emitting circuit 846 is disposed on the second insulating carrier 841 of the second light-emitting device 840, and two ends of the seventh light-emitting circuit 846 are connected to the seventh conductive layer 843 and the eighth conductive layer 844 respectively, and the seventh light-emitting circuit 846 has at least a seventh light-emitting unit 846a directed from the eighth conductive layer 844 to the seventh conductive layer 843 to connect to the sixth light-emitting circuit 842 in anti-parallel. The seventh conductive layer 843 can connect to the sixth conductive layer 832 and the third conductive layer 826 of the first light-emitting device 820 via a wire 817, and the eighth conductive layer 844 can connect to a first conductive layer 823′ and a fifth conductive layer 830′ of the third light-emitting device 820′ via a wire 818. A third conductive layer 826′ and a sixth conductive layer 832′ of the third light-emitting device 820′ can be jointly connected to the second contact 860b of the AC power supply 860 via a wire 819, and further combine with the first conductive layer 823 and the fifth conductive layer 830 of the first light-emitting device 820 to connect to the first contact 860a of the AC power supply 860 for power supply. The wire 817 can be formed by connecting to the third conductive layer 826 and the sixth conductive layer 832 close to the third conductive layer 826 of the first light-emitting device 820 by wire bonding and the wire 818 and wire 819 can be formed by the same method. Nevertheless, the wire 817, 818, and 819 can be formed by the lithography process other than wire bonding. For example, the third conductive layer 826 and the sixth conductive layer 832 close to the third conductive layer 826 can be bonded together by a conductive welding-bump, and then the wire 817 can be formed by lithography process to connect to the third conductive layer 826 or the sixth conductive layer 832.

The working voltages of the first light-emitting device 820 and the third light-emitting device 820′ can be less than 100 V respectively, and the working voltage of the second light-emitting device 840 can be greater than 5 V and less than 100 V. With less working voltages, the light-emitting efficiency of the light-emitting units of the first light-emitting device 820, the second light-emitting device 840, and the third light-emitting device 820′ are increased. Besides, the light-converting material can be distributed in the first light-emitting device 820, second light-emitting device 840, and the third light-emitting device 820′ uniformly, non-uniformly, or by way of gradually concentration-changing.

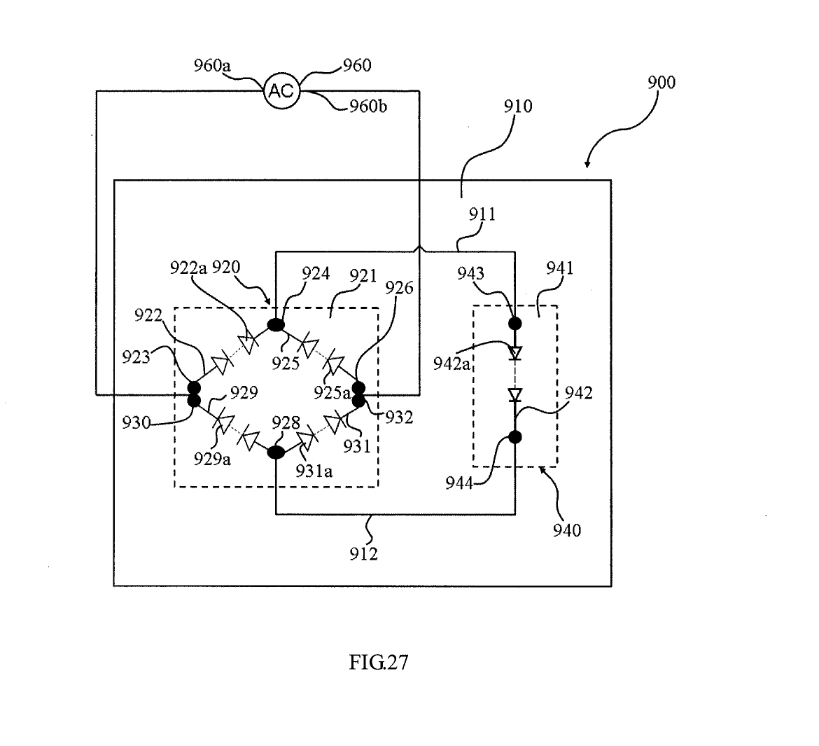

Referring to FIG. 27, a schematic diagram of circuit of a light-emitting module of an embodiment of the present application is disclosed. A light-emitting module 900 includes a carrier 910, a first light-emitting device 920 disposed on the carrier 910, and a second light-emitting device 940 disposed on the carrier 910. The first light-emitting device 920 includes a first insulating carrier 921. The first insulating carrier 921 has a first light-emitting circuit 922 thereon, and two ends of the first light-emitting circuit 922 are connected to a first conductive layer 923 and a second conductive layer 924, and the first light-emitting circuit 922 includes a first light-emitting unit 922a directed from the first conductive layer 923 to the second conductive layer 924. The first insulating carrier 921 has a second light-emitting circuit 925 thereon, and two ends of the second light-emitting circuit 925 are connected to the second conductive layer 924 and a third conductive layer 926, and the second light-emitting circuit 925 includes a second light-emitting unit 925a directed from the third conductive layer 926 to the second conductive layer 924. The first insulating carrier 921 has a third light-emitting circuit 929 thereon, and two ends of the third light-emitting circuit 929 are connected to the forth conductive layer 928 and a fifth conductive layer 930, and the third light-emitting circuit 929 includes a third light-emitting unit 929a directed from the forth conductive layer 928 to the fifth conductive layer 930. The first insulating carrier 921 has a forth light-emitting circuit 931 thereon, and two ends of the forth light-emitting circuit 931 are connected to the forth conductive layer 928 and a sixth conductive layer 932, and the forth light-emitting circuit 931 includes a forth light-emitting unit 931a directed from the forth conductive layer 928 to the sixth conductive layer 932.

The second light-emitting device 940 includes a second insulating carrier 941, and the second insulating carrier 941 has at least a fifth light-emitting circuit 942 thereon, and two ends of the fifth light-emitting circuit 942 are electrically connected to a seventh conductive layer 943 and an eighth conductive layer 944, and the fifth light-emitting circuit 942 includes a fifth light-emitting unit 942a directed from the seventh conductive layer 943 to the eighth conductive layer 944.

A bridge-type circuit can be formed by connecting the seventh conductive layer 943 to the second conductive layer 924 via a wire 911; connecting the eighth conductive layer 944 to the forth conductive layer 928 via a wire 912; and connecting the first conductive layer 923 and the fifth conductive layer 930 to a first contact 960a of an AC power supply 960, and then connecting the third conductive layer 926 and the sixth conductive layer 932 to a second contact 960b of the AC power supply 960.

The way to connect the first light-emitting device 920 to the AC power supply and to connect the first light-emitting device 920 to the second light-emitting device 940 can be referred to the aforesaid embodiments. Similar to the aforesaid embodiments, all of the conductive layers of the present embodiment can great about 1.9×103 μm2 and can be 3.8×103 μm2 for wire bonding process, while when the wire between the light-emitting device 920 and the second light-emitting device 940 is formed by lithography process, the conductive layers for connecting can have smaller areas.

The light-emitting module 900 can further include a light-converting material (not shown) spread in the first light-emitting device 920 and/or the second light-emitting device 940, and the light-converting material can be a yellow-green phosphor and is distributed in the light-emitting device 900 uniformly, non-uniformly, or by way of gradually concentration-changing. The first light-emitting unit 922a, the second light-emitting unit 925a, the third light-emitting unit 929a, and the forth light-emitting unit 931a of the first light-emitting device 920 are red light-emitting units, and the fifth light-emitting unit 942a is a blue light-emitting unit, by mixing the three primary colors comprising red, blue, and green to form white light for illumination. The wavelengths of the first light-emitting unit 922a, second light-emitting unit 925a, third light-emitting unit 929a, and forth light-emitting unit 931a emitting red light are respectively 50 nm more than that of the fifth light-emitting unit 922a emitting blue light. The red light-emitting units can stand higher reverse-voltage than the blue light-emitting units so the first light-emitting unit 922a, the second light-emitting unit 925a, the third light-emitting unit 929a, and the forth light-emitting unit 931a emitting red light are arranged on the periphery of the bridge-type circuit and the amount of the light emitting units can be reduced to increase the proportion of the light-emitting units that emits light simultaneously. The colors of the emitting lights of the first light-emitting device 920 and the second light-emitting device 940 can be exchanged.

The ratio of the working voltages of the blue light-emitting unit to the red light-emitting unit is more than about 3; the ratio of the powers of the blue light-emitting unit and the red light-emitting unit is more than about 2; and the ratio of the total emitting-area of the blue light-emitting unit and the red light-emitting unit is more than about 2.

In the aforesaid embodiments, III-V group materials are firstly grown on an insulating carrier by epitaxial method to form each light-emitting unit, and channels are formed by etching to insulate each light-emitting unit from others, and electrodes are formed on each light-emitting unit. Each light-emitting unit is connected to another via a metal line, and the forming method of each conductive layer including firstly etching the epitaxial layers by lithography and etching process to expose the insulating carrier, and then forming the conductive layer on the insulating carrier by coating.

In the aforesaid embodiments, each light-emitting unit can be formed by wafer bonding. Firstly a semiconductor light-emitting stack is grown on another growing substrate (not shown) by epitaxial method to form an epitaxial wafer, and the growing materials are semiconductor materials including III-V group materials such as GaN, GaP, GaAs, or □-□ group materials, and then the light-emitting stack is attached to a permanent carrier via an adhesive layer, or is bonded thereto by directly heating and pressure, and each light-emitting unit is defined by etching and is insulated from each other by the channels by etching. The growing substrate can selectively be thinned or removed after the light-emitting stack connecting to the permanent carrier.

The material of the permanent carrier can include conductive materials or insulative materials, wherein the conductive material of the permanent carrier can be Si, GaAs, SiC, GaAsP, AlGaAs, AlN, or metal, and the insulative material of the permanent carrier can be sapphire, glass, or quartz.

When a conductive material is selected to be the permanent carrier for wafer bonding, the bonding layer for connecting can be insulative materials such as PI, BCB, PFCB, SOG, or SiO2. In the aforesaid embodiments, each light-emitting unit includes light-emitting diode; the bonding layer can be metal, SiOx, adhesive glue, or metal oxide, wherein the metal can be Ag, Au, Al, or In, and the adhesive glue can be PI, BCB, PFCB; the permanent carrier of the conductive materials are composed to a insulating carrier for carrying and having insulative feature; and after the bonding process, the epitaxial wafer is partially etched to the insulative bonding layer, and the each light-emitting unit is insulated from each other by the channels.

When the permanent carrier is an insulative carrier, an insulative material or a conductive material can be selected to be the bonding layer. When an insulative material is selected to be the bonding layer and after wafer bonding, the epitaxial wafer is partially etched to the insulative bonding layer or the permanent carrier, and the each light-emitting unit is insulated from each others by the channels. When a conductive material is selected to be the bonding layer and after wafer bonding, the epitaxial wafer is partially etched to the permanent carrier, and the each light-emitting unit is insulated from each other by the channels.

The conductive material of the aforesaid bonding layer includes metal or conductive metal oxide, wherein the metal includes Au, Ag, Sn, In, Pb, Cu, or Pt, and the metal oxide include ITO, CdSnO, TiSnO, ZnO, or ZnSnO.

In the aforesaid embodiments, for different circuit design of each light-emitting device, the light-emitting device is connected to an external power supply via a wire, so that each conductive is functional for carrying wires, in this way the area of each conductive layer is needed to be sufficient enough for the wires of wire bonding, and the area is greater or equal to 1.9×10³ μm²; the aforesaid each light-emitting circuit can include multiple light-emitting units; the array-type light-emitting device of the aforesaid embodiments can further connect multiple array-type light-emitting devices in series; the materials of the first conductive layer, the second conductive layer; the third conductive layer; the forth conductive layer, the fifth conductive layer, and the sixth conductive layer include metal or conductive metal oxide; the materials of the insulating carrier 10 include sapphire, glass, or quartz.

What is claimed is:

1. A light-emitting device comprising:
an insulating carrier;
a first conductive layer formed on the insulating carrier;
a second conductive layer formed on the insulating carrier;
a third conductive layer formed on the insulating carrier;
a fourth conductive layer formed on the insulating carrier;
a fifth conductive layer formed on the insulating carrier; and
an light-emitting diode array, comprising:
at least a first light-emitting unit formed on the insulating carrier and electrically connected to the first conductive layer and the second conductive layer, and a circuit direction of the first light-emitting unit is from the first conductive layer to the second conductive layer;
at least a second light-emitting unit formed on the insulating carrier and electrically connected to the second conductive layer and the third conductive layer, and a circuit direction of the second light-emitting unit is from the third conductive layer to the second conductive layer;
at least a third light-emitting unit formed on the insulating carrier and electrically connected to the second conductive layer and the fourth conductive layer, and a circuit direction of the third light-emitting unit is from the second conductive layer to the fourth conductive layer; and
at least a fourth light-emitting unit formed on the insulating carrier and electrically connected to the fourth conductive layer and the fifth conductive layer, and a circuit direction of the fourth light-emitting unit is from the fourth conductive layer to the fifth conductive layer;
wherein an area of each one of the first to the fifth conductive layers is greater or equal to 1.9×10³ μm²;
wherein the first to the fifth conductive layers are capable of being selectively wire bonded so that the light-emitting diode array can be driven by a current.

2. The array-type light-emitting device according to claim 1, wherein the current is a DC current, the light-emitting diode array is configured as a serial connection circuit, a parallel connection circuit or a serial-parallel connection circuit by selectively wire bonding the first to the fifth conductive layers.

3. The array-type light-emitting device according to claim 1, wherein the current is an AC current, the light-emitting diode array is configured as a reverse-parallel connection circuit or an AC bridge circuit by selectively wire bonding the first to the fifth conductive layers.

4. The array-type light-emitting device according to claim 2, wherein the serial connection circuit comprises one of the light-emitting units and two of the conductive layers electrically connecting the one of the light-emitting units.

5. The array-type light-emitting device according to claim 4, wherein the two of the conductive layers are connected to two contacts of a DC power for supplying the DC current, respectively, to form the serial connection circuit simply comprising the one of the light-emitting units and devoid of any other one of the light-emitting units.

6. The array-type light-emitting device according to claim 2, wherein the serial connection circuit comprises the first conductive layer, the second conductive layer, the fourth conductive layer, the first light-emitting unit and the third light-emitting unit; or wherein the serial connection circuit comprises the second conductive layer, the third conductive layer, the fourth conductive layer, the second light-emitting unit, and the third light-emitting unit.

7. The array-type light-emitting device according to claim 6, wherein the first conductive layer and the fourth conductive layer are connected to two contacts of a DC power supplying the DC current respectively, and the serial connection circuit simply comprises the first light-emitting unit and the third light-emitting unit; or wherein the third conductive layer and the fourth conductive layer are connected to two contacts of the DC power supplying the DC current respectively, and the serial connection circuit simply comprises the second light-emitting unit and the third light-emitting unit.

8. The array-type light-emitting device according to claim 2, wherein the parallel connection circuit comprises the first conductive layer, the second conductive layer, the third conductive, the first light-emitting unit and the second light-emitting unit.

9. The array-type light-emitting device according to claim 8, wherein the first conductive layer and the third conductive are connected to a contact of a DC power supplying the DC current, and the second conductive layer is connected to another contact of the DC power.

10. The array-type light-emitting device according to claim 2, wherein the serial-parallel connection circuit comprises the first conductive layer, the second conductive layer, the third conductive layer, the fourth conductive layer, the fifth conductive layer, the first light-emitting unit, the second light-emitting unit, the third light-emitting unit and the fourth light-emitting unit; or wherein the serial-parallel connection circuit comprises the first conductive layer, the second conductive layer, the third conductive layer, the fourth conductive layer, the first light-emitting unit, the second light-emitting unit and the third light-emitting unit.

11. The array-type light-emitting device according to claim 10, wherein the first conductive layer and the third conductive layer are connected to a contact of a DC power supplying the DC current, and the fifth conductive layer is connected to another contact of the DC power; or the first conductive layer and the third conductive layer are connected to a contact of a DC power supplying the DC current, and the fourth conductive layer is connected to another contact of the DC power.

12. The array-type light-emitting device according to claim 3, wherein the reverse-parallel connection circuit comprises the first, second, third, fourth, and fifth conductive layers, and, the first, second, third, and fourth light-emitting units, and wherein the first conductive layer and the fifth conductive layer are connected to a contact of the AC power supplying the AC current, and the third conductive layer and the fourth conductive layer are connected to another contact of the AC power.

13. The array-type light-emitting device according to claim 1, further comprising a sixth conductive layer formed on the insulating carrier, and at least a fifth light-emitting unit formed on the insulating carrier and electrically connected to the fourth conductive layer and the sixth conductive layer, wherein a circuit direction of the fifth light-emitting unit is from the fourth conductive layer to the sixth conductive layer; wherein an area of the sixth conductive layers is greater or equal to 1.9×10³ μm².

14. The array-type light-emitting device according to claim 13, wherein the current is a DC current; wherein the light-emitting diode array is configured as a serial connection circuit comprising the first, second, third, fourth, fifth, and sixth conductive layers, and the first, second, third, fourth, and fifth light-emitting units, and wherein the first conductive layer and the third conductive layer are connected to a contact of a DC power supplying the DC current, and the fifth conductive layer and the sixth conductive layer are connected to another contact of the DC power.

15. The array-type light-emitting device according to claim 13, wherein the current is an AC current; wherein the light-emitting diode array is configured as an AC bridge circuit comprising the first, second, third, fourth, fifth, and sixth conductive layers, and the first, second, third, fourth, and fifth light-emitting units, and wherein the first conductive layer and the fifth conductive layer are connected to a contact of an AC power supplying the AC current, and the third conductive layer and the sixth conductive layer are connected to another contact of the AC power.

16. The array-type light-emitting device according to claim 13, wherein the first and the second conductive layers are adjacent to each other and the third and the sixth conductive layers are adjacent to each other.

17. The array-type light-emitting device according to claim 16, wherein the first and the second conductive layers are bonded together by a conductive welding-bump.

18. The array-type light-emitting device according to claim 1, wherein the insulating carrier comprises a growth substrate.

19. The array-type light-emitting device according to claim 1, wherein the first to the fifth conductive layers and the first to the fourth light-emitting units are formed on a same side of the insulating carrier.

20. A light-emitting device comprising:
an insulating carrier;
a first, second, third, fourth, and five conductive layers formed on the insulating carrier; and
an light-emitting diode array, comprising:
at least a first light-emitting unit formed on the insulating carrier and electrically connected to the first conductive layer and the second conductive layer, and a circuit direction of the first light-emitting unit is from the first conductive layer to the second conductive layer;
at least a second light-emitting unit formed on the insulating carrier and electrically connected to the second conductive layer and the third conductive layer, and a circuit direction of the second light-emitting unit is from the third conductive layer to the second conductive layer;
at least a third light-emitting unit formed on the insulating carrier and electrically connected to the second conductive layer and the fourth conductive layer, and a circuit direction of the third light-emitting unit is from the second conductive layer to the fourth conductive layer; and
at least a fourth light-emitting unit formed on the insulating carrier and electrically connected to the fourth conductive layer and the fifth conductive layer, and a circuit direction of the fourth light-emitting unit is from the fourth conductive layer to the fifth conductive layer;
wherein an area of each one of the first to the fifth conductive layers is greater or equal to 1.9×10³ μm²;
wherein the array-type light-emitting device comprises a first connecting type when connecting with a DC external power and a second connecting type when connecting with an AC external power;
wherein at least two of the first to the fifth conductive layers are connected to the DC external power in the first connecting type, and the array-type light-emitting device is configured as a serial connection circuit, a parallel connection circuit or a serial-parallel connection circuit in the first connecting type;
wherein at least two of the first to the fifth conductive layers are connected to the AC external power in the second connecting type, and the array-type light-emitting device is configured as a reverse-parallel connection circuit or an AC bridge circuit.
